(19) United States
(12) Patent Application Publication
(10) Pub. No.: US 2026/0079973 A1
(43) Pub. Date: Mar. 19, 2026

(54) DOCUMENT QUESTION-ANSWERING DATA GENERATION METHOD, ELECTRONIC DEVICE AND STORAGE MEDIUM

(71) Applicant: Beijing Baidu Netcom Science Technology Co., Ltd., Beijing (CN)

(72) Inventors: Jingbo Zou, Beijing (CN); Pengfei Luo, Beijing (CN)

(21) Appl. No.: 19/402,683

(22) Filed: Nov. 26, 2025

(30) Foreign Application Priority Data
Sep. 19, 2025 (CN) 202511349210.6

(51) Int. Cl. G06F 16/3329; G06F 16/334

(52) U.S. Cl. CPC G06F 16/33295; G06F 16/3347

(57) ABSTRACT

The present disclosure provides a method for generating document question-answering data, a training method, a generating apparatus, an electronic device, a computer-readable storage medium, and a computer program product. The method includes: extracting page content from page images in a document to obtain descriptive information corresponding to seed pages in the document; generating a reasoning chain corresponding to the seed pages by using a preset question-answering data generation model based on the descriptive information, question definitions of preset question types, and question-answering examples of the preset question types; and in response to the reasoning chain constituting a question-type reasoning chain corresponding to the preset question types, generating question-answering data corresponding to the preset question types by using the question-answering data generation model based on the question-type reasoning chain.

### CROSS-REFERENCE TO RELATED APPLICATIONS

This application claims the priority from Chinese Patent Application No. 202511349210.6, filed on Sep. 19, 2025, the entire disclosure of which is hereby incorporated by reference.

### TECHNICAL FIELD

The present disclosure relates to the field of data processing technologies, specifically to the field of artificial intelligence technologies such as large language models and deep learning, and in particular to a document question-answering data generation method, an electronic device, and a computer-readable storage medium.

### BACKGROUND

Currently, automated data synthesis processes based on documents mostly adopt simple template generation or question reuse methods. This method results in low quality and lack of diversity of synthesized data, so the generated document question-answering data is often relatively simple and difficult to cover complex question types.

### SUMMARY

Embodiments of the present disclosure propose a document question-answering data generation method, a training method, a generation apparatus, an electronic device, a computer-readable storage medium, and a computer program product.

In a first aspect, embodiments of the present disclosure provide a method for generating document question-answering data, including: extracting page content from page images in a document to obtain descriptive information corresponding to seed pages in the document; generating a reasoning chain corresponding to the seed pages by using a preset question-answering data generation model based on the descriptive information, question definitions of preset question types, and question-answering examples of the preset question types; where the preset question types include multi-hop questions and/or set questions; and in response to the reasoning chain constituting a question-type reasoning chain corresponding to the preset question types, generating question-answering data corresponding to the preset question types by using the question-answering data generation model based on the question-type reasoning chain.

In a second aspect, embodiments of the present disclosure provide an electronic device, the electronic device including: at least one processor; and a memory communicatively connected to the at least one processor; where the memory stores instructions executable by the at least one processor, and the instructions are executed by the at least one processor to enable the at least one processor to implement the document question-answering data generation method described in the first aspect when executed.

In a third aspect, embodiments of the present disclosure provide a non-transitory computer-readable storage medium storing computer instructions, the computer instructions being used to enable a computer to implement the document question-answering data generation method described in the first aspect when executed.

It should be understood that the description in this section is not intended to identify key or critical features of the embodiments of the disclosure, nor is it intended to limit the scope of the disclosure. Other features of the present disclosure will become readily apparent from the following description.

### BRIEF DESCRIPTION OF THE DRAWINGS

By reading the detailed description of non-limiting embodiments made with reference to the following drawings, other features, purposes, and advantages of the present disclosure will become more apparent:

FIG. 1 is an exemplary system architecture to which the present disclosure may be applied;

FIG. 2 is a flowchart of a document question-answering data generation method provided by an embodiment of the present disclosure;

FIG. 3 is a flowchart of another document question-answering data generation method provided by an embodiment of the present disclosure;

FIG. 4 is a schematic flowchart of a document question-answering data generation method in an application scenario provided by an embodiment of the present disclosure;

FIG. 5 is a structural block diagram of a document question-answering data generation apparatus provided by an embodiment of the present disclosure;

FIG. 6 is a structural schematic diagram of an electronic device adapted for executing the document question-answering data generation method provided by an embodiment of the present disclosure.

### DETAILED DESCRIPTION OF EMBODIMENTS

The following description of exemplary embodiments of the present disclosure, taken in conjunction with the accompanying drawings, includes various details of embodiments of the present disclosure to facilitate understanding, and is to be considered as exemplary only. Accordingly, one of ordinary skill in the art will recognize that various changes and modifications may be made to the embodiments described herein without departing from the scope and spirit of the disclosure. Also, for clarity and conciseness, descriptions of well-known functions and structures are omitted from the following description. It should be noted that the embodiments in the present disclosure and the features in the embodiments may be combined with each other without conflict.

In the technical solution of the present disclosure, the collection, storage, use, processing, transmission, provision, and disclosure of user personal information involved all comply with relevant laws and regulations and do not violate public order and good customs.

In the field of data processing, especially in the field of document processing and retrieval-augmented generation, document question-answering tasks can comprehensively utilize data information in documents to provide users with more comprehensive and accurate content understanding and retrieval services for various questions. To realize the model's deep understanding of document content and accurate answering of user questions, current document question-answering systems generally rely on a large amount of high-quality question-answer training data. In related technologies, manual annotation methods or automated synthesis methods are generally used to obtain document question-answering data.

The manual annotation method is usually completed by professional annotators or crowdsourcing teams. The specific process of generating document question-answering data includes: first collecting documents containing various types of information; then annotators reading each document one by one, designing targeted questions and answers combined with different information contained in the documents, annotating answers for each question, and conducting quality review to form a structured question-answering data set. However, the data scale of this method is limited and difficult to expand on a large scale; the annotation process is time-consuming and labor-intensive with high costs; moreover, this method relies on manual experience, which is prone to subjective biases and difficult to ensure data consistency and comprehensiveness.

The automated synthesis method generally relies on preset templates or rule engines. The specific process of generating document question-answering data includes: first, performing structured parsing on document content to extract text paragraphs, image descriptions, table data and other information; then automatically generating questions related to the document content according to preset question-answering templates or generation rules, and extracting or calculating answers from the documents; finally, organizing the generated questions and answers to form an automatically synthesized data set. However, this method usually relies on template generation or simple rules, resulting in a single question type, which is difficult to cover high-level tasks such as complex reasoning and multi-hop question-answering. Therefore, the questions generated by this method are mostly surface-level fact extraction, lacking question designs for cross-modal and deep understanding, and the data diversity and quality are insufficient, which affects the training effect and practical application ability of the model.

Based on the problems existing in the above related technologies, the embodiments of the present disclosure provide a document question-answering data generation scheme capable of automatically generating high-quality question-answer pairs, which significantly improves data diversity and difficulty.

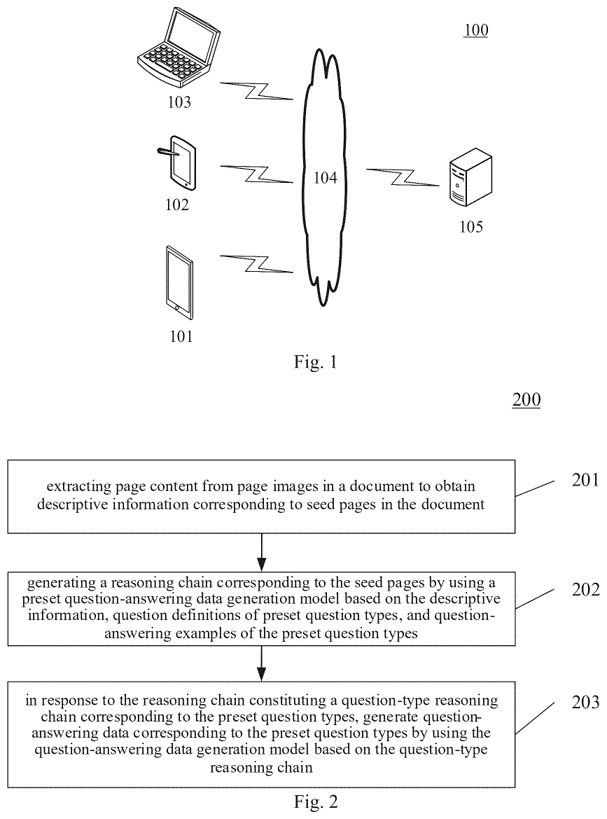

FIG. 1 shows an exemplary system architecture 100 to which the document question-answering data generation method, apparatus, electronic device, and computer-readable storage medium of the present disclosure may be applied.

As shown in FIG. 1, the system architecture 100 may include terminal devices 101, 102, 103, a network 104, and a server 105. The network 104 serves as a medium for providing communication links between the terminal devices 101, 102, 103 and the server 105. The network 104 may include various connection types, such as wired, wireless communication links, or optical fiber cables.

Users may use the terminal devices 101, 102, 103 to interact with the server 105 through the network 104 to receive or send messages and the like. Various applications for realizing information communication between the two may be installed on the terminal devices 101, 102, 103 and the server 105, such as data transmission applications, instant messaging applications, and the like.

The terminal devices 101, 102, 103 and the server 105 may be hardware or software. When the terminal devices 101, 102, 103 are hardware, they may be various electronic devices with display screens, including but not limited to smartphones, tablet computers, laptop portable computers, desktop computers, and the like; when the terminal devices 101, 102, 103 are software, they may be installed in the above-listed electronic devices, and may be implemented as multiple software pieces or software modules, or as a single software piece or software module, which is not specifically limited here. When the server 105 is hardware, it may be implemented as a distributed server cluster composed of multiple servers, or as a single server; when the server is software, it may be implemented as multiple software or software modules, or as a single software piece or software module, which is not specifically limited here.

The server 105 may provide various services through built-in various applications. Taking providing document question-answering data generation applications as an example, the server 105 may achieve the following effects when running the document question-answering data generation applications: first, extracting page content from page images in a document to obtain descriptive information corresponding to seed pages in the document; generating a reasoning chain corresponding to the seed pages by using a preset question-answering data generation model based on the descriptive information, definitions of preset question types, and examples of preset question types; where the preset question types include multi-hop questions and/or set questions; in response to the reasoning chain constituting a question-type reasoning chain corresponding to the preset question types, and generating question-answering data corresponding to the preset question types by using the question-answering data generation model based on the question-type reasoning chain.

It should be noted that the page images in the document, the definitions of preset question types, and the examples of the preset question types may be obtained from the terminal devices 101, 102, 103 through the network 104, or may be pre-stored locally in the server 105 in various ways. Therefore, when the server 105 detects that such data has been stored locally (for example, retaining page images in the document, definitions of preset question types, and examples of the preset question types before starting processing), the server may choose to directly obtain such data locally. In this case, the exemplary system architecture 100 may not include the terminal devices 101, 102, 103 and the network 104.

Since document question-answering data generation requires many computing resources and strong computing capabilities, the document question-answering data generation method provided by the subsequent embodiments of the present disclosure is generally executed by the server 105 with strong computing capabilities and many computing resources. Correspondingly, the document question-answering data generation apparatus is generally also arranged in the server 105. However, it should also be noted that when the terminal devices 101, 102, 103 also have the required computing capabilities and computing resources, the terminal devices 101, 102, 103 may also complete the above-mentioned calculations entrusted to the server 105 through the installed document question-answering data generation applications, and then output the same results as the server 105. Especially when there are multiple terminal devices with different computing capabilities, but the document question-answering data generation application determines that the terminal device where the application is located has strong computing capabilities and sufficient remaining computing resources, the terminal device may be allowed to execute the above calculations, thereby appropriately reducing the computing pressure on the server 105. Correspondingly, the document question-answering data generation apparatus may also be set in the terminal devices 101, 102, 103. In this case, the exemplary system architecture 100 may not include the server 105 and the network 104.

It should be understood that the number of terminal devices, networks, and servers in FIG. 1 is only schematic. According to the implementation needs, there may be any number of terminal devices, networks, and servers.

Please refer to FIG. 2. FIG. 2 is a flowchart of a document question-answering data generation method provided by an embodiment of the present disclosure. The method may be applied to the system architecture 100 shown in FIG. 1 (for example, the server 105 shown in FIG. 1), and may also be applied to a processor or an electronic device, etc., which is not limited by the present disclosure. The process 200 includes the following steps:

Step 201 includes: extracting page content from page images in a document to obtain descriptive information corresponding to seed pages in the document.

Specifically, the document may be a multi-modal document, including various modal information such as text, images, and tables. The multi-modal document D={pᵢ}ᵢ₌₁^{N} is a set composed of a series of page images pᵢ, N is the total number of pages of the multi-modal document, and the value is a positive integer greater than 0. In other words, the page image refers to each page of the multi-modal document, and the page image may include multi-modal information such as documents, images, and tables.

Extracting page content from page images in the document specifically refers to, for each page image in the document, extracting structured content such as text blocks, tables, and image descriptions in the page image, generating descriptive information for each page image, and then obtaining descriptive information related to the seed pages in the document according to the descriptive information of each page image. A seed page refers to a page image selected from all page images in the document. The seed page usually serves as the starting point in the process of generating document question-answering data. After obtaining the above document content, a question for the document D may be constructed starting from the seed page. First, randomly select one page image pᵢ from all page images of the document D as the seed page.

Optionally, the descriptive information corresponding to the seed page may be obtained only according to the page content in the seed page, or may be obtained based on the page content in page images other than the seed page.

Specifically, the descriptive information corresponding to the seed page in the document is the basis for generating document question-answering data. If the information contained in the current seed page is sufficient, the corresponding descriptive information may be obtained only based on the page content of the seed page. If the page content contained in the seed page is limited, the page content of the seed page may be supplemented based on the page content in page images other than the seed page in the document to obtain the descriptive information corresponding to the seed page.

Optionally, a large language model may be used to perform joint understanding of vision and text on the text, images, tables, etc. in the page images of the document, thereby generating descriptive information for each page image. Optionally, a neural network model may also be used to perform semantic recognition and image and table recognition on the text, images, tables, etc. in the page images of the document through feature extraction, thereby generating descriptive information for each page image, which is not limited by the present disclosure.

By extracting page content from the multi-modal document, the embodiments of the present disclosure enable the multi-modal document question-answering task to comprehensively utilize various modal information such as text, images, and tables in the document, providing users with more comprehensive and accurate content understanding and retrieval services for various questions.

Step 202 includes: generating a reasoning chain corresponding to the seed pages by using a preset question-answering data generation model based on the descriptive information, question definitions of preset question types, and question-answering examples of the preset question types.

The preset question types include multi-hop questions and/or set questions.

Specifically, the preset question-answering data generation model may be a large language model. The model first identifies core themes, key entities (such as person names, places, professional terms), important dates, data, causal relationships, operation steps, etc. based on the descriptive information, then performs logical reasoning on the key entities, important dates, causal relationships, operation steps, etc. in the descriptive information according to the question definitions of the preset question types and the question-answering examples of the preset question types to generate a reasoning chain, so as to determine whether the question-answering data corresponding to the preset question types can be generated based on the reasoning chain. The examples of the preset question types refer to question-answer examples of the preset question types, so that the question-answering data generation model can more accurately infer and determine whether the question-answering data corresponding to the preset question types can be generated based on the question definitions of the preset questions and combined with specific examples of the preset questions.

The multi-hop question refers to a question for which an answer cannot be found directly from a single source or paragraph. To answer a multi-hop question, multiple “reasoning hops” must be performed, that is, connecting multiple information fragments for logical reasoning or comprehensive determination. The core feature of a multi-hop question is that the question involves one entity, and reasoning and multiple steps are required based on the entity.

An example of a multi-hop question may be: “What is the birthday of A's wife?” This multi-hop question only involves one entity A, and then reasoning is performed based on the entity A to obtain the final answer. First, the first hop determines A's wife B based on A, and then the second hop determines B's birthday.

A set question refers to a question whose answer is not a single entity but a set (i.e., a list or a group of entities). The goal of the question is to enumerate all items that meet specific conditions. The core features of a set question are that the question involves multiple entities and the answer is plural.

An example of a set question may be: “Which Chinese people are both directors and actors?” This set question involves two entities: directors and actors. First, it is necessary to determine the set of all Chinese directors, then determine the set of all Chinese actors, and then find the set-intersection of the two sets to obtain the final answer.

Optionally, to further generate high-quality and complex-structured questions, the examples of the preset question types may also be examples that include both multi-hop questions and set questions. In this way, when the descriptive information is sufficient, based on the question definitions of the preset question types and the examples of the preset question types, complex question-answering data including both multi-hop questions and set questions may also be generated.

For example, an example that includes both multi-hop questions and set questions may be: “Who are the wives of Chinese people who are both directors and actors”. This example adds a multi-hop question on the basis of the above set example. First, the Chinese people C who are both directors and actors are determined based on the set question, and then the wives of C are determined through multi-hop based on C to obtain the final answer.

Examples that include both multi-hop questions and set questions may also intersperse set questions between multi-hops, etc. The present disclosure does not limit the examples of the preset question types.

The preset question types may be one or more. When the preset question type is one, the specified question-answering data may be generated; and when the preset question types are multiple, the most matching question-answering data among the multiple preset question types may be generated based on the descriptive information.

Specifically, in practical application scenarios, the type and quantity of questions to be generated are generally specified for the document D. For example, 100 multi-hop questions are generated first, and then 200 set questions are generated. In this case, multi-hop questions and set questions may be generated in sequence based on requirements. Therefore, when generating multi-hop questions, only the descriptive information, the question definitions of multi-hop questions, and the question-answering examples of multi-hop questions need to be input into the preset question-answering data generation model; similarly, when generating set questions, only the descriptive information, the question definitions of set questions, and the question-answering examples of set questions need to be input into the preset question-answering data generation model. That is, if the question type for which question-answering data needs to be generated is specified in a practical application scenario, when generating the corresponding reasoning chain by using the preset question-answering data generation model, only the question definition of the specified question type and the question-answering example of the specified question type need to be used as inputs.

In other application scenarios, the question type for which question-answering data needs to be generated may not be specified. In this scenario, the definitions of all preset question types and the question-answering examples of all preset question types need to be used as inputs of the preset question-answering data generation model. In this way, the preset question-answering data generation model may generate the best document question-answering data based on the descriptive information, improving the quality and efficiency of the generated question-answering data.

Step 203 includes: in response to the reasoning chain constituting a question-type reasoning chain corresponding to the preset question types, generate question-answering data corresponding to the preset question types by using the question-answering data generation model based on the question-type reasoning chain.

Specifically, in the present disclosure, the correspondence between the reasoning chain and the preset question types means that the reasoning chain corresponds to at least part of the preset question types. In other words, if the preset question type is a multi-hop question, the correspondence between the reasoning chain and the preset question type means that the reasoning chain corresponds to the multi-hop question; similarly, if the preset question type is a set question, the correspondence between the reasoning chain and the preset question type means that the reasoning chain corresponds to the set question; if the preset question types are multi-hop questions and set questions, the correspondence between the reasoning chain and the preset question types means that the reasoning chain corresponds to the multi-hop questions and/or the set questions.

If the reasoning chain output by the question-answering data generation model includes a chained reasoning chain corresponding to the multi-hop question, it indicates that the reasoning chain corresponding to the multi-hop question may be generated according to the descriptive information, thereby indicating that the multi-hop question may be formed based on the descriptive information. Therefore, the question-answering data generation model further generates corresponding multi-hop question-answering data based on the reasoning chain and the question definition of the multi-hop question. Similarly, if the reasoning chain output by the question-answering data generation model includes a chained reasoning chain corresponding to the set question, it indicates that the reasoning chain corresponding to the set question may be generated according to the descriptive information, thereby indicating that the set question may be formed based on the descriptive information. Therefore, the question-answering data generation model further generates corresponding set question-answering data based on the reasoning chain and the question definition of the set question.

In addition, when the reasoning chain includes both a chained reasoning chain corresponding to the multi-hop question and a set-operation reasoning chain corresponding to the set question, it indicates that the reasoning chain corresponding to the multi-hop question and the reasoning chain corresponding to the set question may be generated according to the descriptive information, thereby indicating that the multi-hop question and the set question may be formed based on the descriptive information. Therefore, the question-answering data generation model further generates comprehensive question-answering data including both multi-hop questions and set questions based on the reasoning chain, the question definition of the set question, and the question definition of the multi-hop question.

The document question-answering data generation method provided by the embodiments of the present disclosure first obtains descriptive information of seed pages by extracting page content from page images in a document, then performs reasoning by using a preset question-answering data generation model based on the descriptive information, question definitions of preset questions, and examples of preset questions, determines whether question-answering data corresponding to the preset questions may be generated based on the descriptive information, and generates corresponding question-answering data when the question-answering data corresponding to the preset questions may be generated based on the descriptive information. The preset question types include multi-hop questions and/or set questions. Thus, the present disclosure may generate complex question-answering data including multi-hop questions and/or set questions based on the descriptive information, improving the quality, diversity, and difficulty of the question-answering data.

In some embodiments, when the preset question types include multi-hop questions and set questions, correspondingly, the question-type reasoning chain is a chained reasoning chain corresponding to the multi-hop questions and/or a set-operation reasoning chain corresponding to the set questions; step 203 in FIG. 2: in response to the reasoning chain constituting a question-type reasoning chain corresponding to the preset question types, generating question-answering data corresponding to the preset question types by using the question-answering data generation model based on the question-type reasoning chain includes: in response to the reasoning chain constituting a question-type reasoning chain corresponding to the preset question types, generating multi-hop question-answering data corresponding to the chained reasoning chain and/or set question-answering data corresponding to the set-operation reasoning chain by using the question-answering data generation model based on the question-type reasoning chain.

Specifically, when the preset question types are two types: multi-hop questions and set questions, the corresponding examples of the preset questions include examples of multi-hop questions and examples of set questions, so that the question-answering data model may have the ability to generate two types of question-type reasoning chains: chained reasoning chains corresponding to multi-hop questions and set-operation reasoning chains corresponding to set questions according to the sufficiency of the descriptive information. Specifically, when the question-answering data model determines that the descriptive information only includes multi-hop logic corresponding to multi-hop based on the descriptive information, the question definition of multi-hop questions, the question definition of set questions, the question-answering examples of multi-hop questions, and the question-answering examples of set questions, the model may generate a chained reasoning chain corresponding to the multi-hop question; when the model determines that the descriptive information only includes set logic corresponding to data sets, the model may generate a set-operation reasoning chain corresponding to the set question; and when the model determines that the descriptive information includes both multi-hop logic corresponding to multi-hop and set logic corresponding to set, the model may generate a chained reasoning chain corresponding to the multi-hop question and a set-operation reasoning chain corresponding to the set question.

For step 201 in FIG. 2 above, extracting page content from page images in a document to obtain descriptive information corresponding to seed pages in the document, a specific implementation manner is given below.

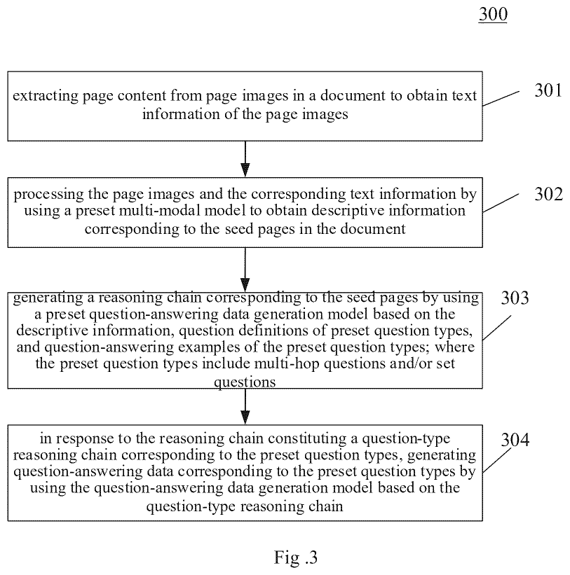

Referring to FIG. 3, FIG. 3 is a flowchart of another document question-answering data generation method provided by an embodiment of the present disclosure. As shown in FIG. 3, the method specifically includes the following steps.

Step 301 includes: extracting page content from page images in a document to obtain text information of the page images.

Specifically, each page content is first parsed comprehensively to extract text, images, tables, etc., from the page image, and the extracted content is converted into text format and output, thereby obtaining the text information of the page image. The formula is expressed as: tᵢ=MLLM(pᵢ), where tᵢ represents the result of text content conversion of the page image pᵢ.

Step 302 includes: processing the page images and the corresponding text information by using a preset multi-modal model to obtain descriptive information corresponding to the seed pages in the document.

Specifically, on the basis of step 301, a multi-modal large model MLLM may be further used to take the page images and the corresponding text information as inputs and output corresponding descriptive information. The formula is expressed as: sᵢ=MLLM(tᵢ, pᵢ), where each sᵢ may be regarded as a statement of an objective fact, such as “The result of indicator B of model X on data set A is C”. It should be noted that the declarative description may come from any content of the page, such as pictures, text, tables, etc. Optionally, the above step 301 may also extract page content from the page images in the document based on the multi-modal model to obtain text information of the page images, which is not limited by the present disclosure.

By using a preset multi-modal model to process the page image in two modalities: the page image and the text information corresponding to the page image, the descriptive information generated by the embodiment of the present disclosure is more accurate and comprehensive than the descriptive information obtained directly according to the content extracted from the page image.

Step 303 includes: generating a reasoning chain corresponding to the seed pages by using a preset question-answering data generation model based on the descriptive information, question definitions of preset question types, and question-answering examples of the preset question types; where the preset question types include multi-hop questions and/or set questions.

Step 304 includes: in response to the reasoning chain constituting a question-type reasoning chain corresponding to the preset question types, generating question-answering data corresponding to the preset question types by using the question-answering data generation model based on the question-type reasoning chain.

Steps 301 to 302 above are a specific implementation manner of step 201 shown in FIG. 2. Steps 303-304 are consistent with steps 202-203 shown in FIG. 2. For the same part, please refer to the corresponding part of the previous embodiment, which will not be repeated here.

To ensure that the obtained descriptive information of the seed page is more comprehensive and rich, step 201 in FIG. 2 above “extracting page content from page images in the document to obtain descriptive information corresponding to the seed page in the document” may obtain declarative descriptive information of the seed page and supplementary descriptive information from other page images. A specific implementation manner is given below.

In some embodiments, extracting page content from page images in a document to obtain descriptive information corresponding to seed pages in the document includes: extracting page content from page images of the seed pages by using a preset multi-modal model to generate text information corresponding to the seed pages, and generating declarative descriptive information of the seed pages based on the page images of the seed pages and the corresponding text information; performing relevance ranking on the page images in the document based on the declarative descriptive information of the seed pages to obtain associated pages of the seed pages; extracting page content from page images of the associated pages by using the multi-modal model to generate text information corresponding to the associated pages, and processing the page images of the associated pages and the corresponding text information to generate supplementary descriptive information of the seed pages; and obtaining the descriptive information of the seed pages based on the declarative descriptive information and the supplementary descriptive information.

Specifically, the present disclosure first obtains a declarative description of the seed page by using a preset multi-modal model; then, after obtaining the declarative descriptive information of the seed page, relevant pages most similar to the declarative descriptive information may be retrieved from the document. For example, the similarity between each page image in the document and the seed page may be calculated to obtain a ranked list of the pages in the document, and then associated pages may be obtained according to the ranking of the page list. Optionally, the similarity between each page image in the document and the seed page may be calculated through a cosine similarity calculation function; one or more keywords may be determined based on the declarative descriptive information of the seed page, and then the similarity between each page image in the document and the seed page may be determined based on the frequency of the keywords appearing in each page; and the similarity between each page image in the document and the seed page may also be determined in other ways, which is not limited by the present disclosure.

It should be noted that after obtaining associated pages based on the ranking of pages, the seed page needs to be excluded; finally, supplementary information related to the seed page is obtained from the associated pages by using the multi-modal model. One or more page images with the highest relevance may be selected as associated pages based on the richness of the declarative descriptive information of the seed page or a preset threshold based on the ranking of pages.

The process of obtaining declarative descriptive information from the seed page and supplementary descriptive information from the associated pages by using the multi-modal model is similar to the embodiment corresponding to FIG. 3 above, which will not be repeated here.

The question-answering data generation method provided by the embodiment of the present disclosure searches for supplementary descriptions related to the declarative descriptive information in other page images except the seed page in the document for the declarative descriptive information of the seed page, which may make the obtained descriptive information more sufficient, thereby generating higher-quality question-answering data according to the descriptive information.

In the process of searching for supplementary descriptions related to the declarative descriptive information based on the declarative descriptive information of the seed page, the “relevance” may be defined as overlapping with the declarative descriptive information, or having the same entity as the declarative descriptive information, or having the same relationship as the declarative descriptive information. A specific implementation manner is given below.

In some embodiments, performing relevance ranking on the page images in the document based on the declarative descriptive information of the seed pages to obtain associated pages of the seed pages includes: determining entities and/or relationships contained in the seed pages based on the declarative descriptive information of the seed pages; retrieving page images containing the entities and/or relationships from the page images in the document to obtain candidate pages; and performing relevance ranking on the candidate pages to obtain associated pages of the seed pages.

Specifically, the present disclosure first identifies entities and relationships in the declarative descriptive information. Then, pages sharing entities and/or relationships with the seed page may be used as candidate pages. Finally, all candidate pages are sorted by relevance, and one or more candidate pages with the highest similarity are selected as associated pages based on the richness of the declarative descriptive information or a preset threshold.

An entity is an objectively existing and distinguishable thing or object. Such as model X, person, place, etc. A relationship is a way of describing the association between entities, which may be a conclusive description, an attribute description, etc.

Optionally, since a multi-hop question is aimed at performing deeper logical reasoning on one entity, for a multi-hop question, page images sharing entities with the seed page may be used as candidate pages. Optionally, since a set question involves set-operations of multiple entities, for the set question, page images sharing relationships with the seed page may be used as candidate pages. In addition, to improve the richness of the descriptive information of the seed page, page images sharing both entities and relationships with the seed page may also be used as candidate pages, which is not limited by the present disclosure.

By selecting page images with the same entities (for example, both describing model X) and/or the same relationships (both being conclusive descriptions) as the declarative descriptive information as candidate pages, and then determining associated pages based on the candidate pages, the supplementary descriptive information obtained based on the associated pages can improve the generation efficiency and generation quality of question-answering data corresponding to multi-hop questions and/or set questions.

In the process of determining associated pages, it is necessary to retrieve page images related to the seed page from the page images in the document and calculate the corresponding similarity. The present disclosure can also improve retrieval efficiency by encoding the declarative descriptive information of the seed page and each page image. A specific implementation manner is given below.

In some embodiments, performing relevance ranking on the page images in the document based on the declarative descriptive information of the seed pages to obtain associated pages of the seed pages includes: performing vector encoding on each page image in the document to obtain an encoded vector corresponding to each page image; performing vector encoding on the declarative descriptive information of the seed pages to obtain an encoded description corresponding to the declarative descriptive information; calculating a similarity score between each encoded vector and the encoded description to obtain a similarity ranking; and determining associated pages of the seed pages based on the similarity ranking.

Specifically, a pre-trained vision-language model, denoted as VLM, may be used to convert each page image into a vector form to obtain an encoded vector eᵢ corresponding to each page image, for subsequent retrieval. VLM may encode both text and images, and may map both to a fixed-length vector. This process may be expressed as:

E=e₁, e₂, . . . , eₙ=VLM(p₁, p₂, . . . , pₙ), where E is a matrix composed of vectors of length d, and e₁, e₂, . . . , eₙ correspond to the vector representation of each page image in the document.

After obtaining the declarative descriptive information sᵢ corresponding to the seed page, the above pre-trained vision-language model VLM may also be used to encode the declarative descriptive information to obtain an encoded description corresponding to the declarative descriptive information. Then, similarity calculation may be performed between the encoded vector and the encoded description to perform similarity ranking on each page image in the document.

Optionally, candidate pages similar to the seed page may also be retrieved from the encoded vectors based on the encoded description, and then similarity calculation may be performed between the encoded vector corresponding to the candidate page and the encoded description to obtain a similarity ranking. The present disclosure can reduce the calculation amount of calculating similarity scores and improve calculation efficiency.

By converting both the page image and the declarative descriptive information of the seed page into vector representations, and then performing retrieval of similar page images and calculation of similarity based on the vector representations, the efficiency of determining associated pages can be improved.

When it is determined by the question-answering data generation model that the descriptive information still cannot form the preset question types (multi-hop questions and/or set questions) based on the declarative descriptive information and supplementary descriptive information of the seed page, it indicates that the current descriptive information is not sufficient. Then, the next page image may be continuously selected based on the previously determined relevance ranking of the page images in the document to supplement the descriptive information. A specific implementation manner is given below.

In some embodiments, the method not only includes steps 201˜203, but also includes: in response to the reasoning chain not including a reasoning chain corresponding to the preset question types, expanding the associated pages based on the similarity ranking to obtain expanded pages; processing the page images of the expanded pages and the corresponding text information by using the multi-modal model to generate expanded descriptive information of the seed page; and regenerating the reasoning chain corresponding to the seed page based on the expanded descriptive information.

The process of processing the page images of the expanded pages and the corresponding text information to generate expanded descriptive information of the seed page is similar to the process of obtaining declarative descriptive information and supplementary descriptive information above, which will not be repeated here.

The present disclosure expands the associated pages based on the similarity ranking, so that a reasoning chain more matching the preset question types may be generated based on the expanded descriptive information, declarative descriptive information, and supplementary descriptive information.

Optionally, before obtaining the expanded pages, the page images in the document may be re-ranked based on the descriptive information (including declarative descriptive information and supplementary descriptive information), the relevance ranking may be updated based on the ranking result, and the associated pages may be expanded based on the updated relevance ranking.

Specifically, since the information contained in the declarative descriptive information is limited, the relevance ranking obtained based on the declarative descriptive information may have errors. The present disclosure performs relevance ranking based on the declarative descriptive information and supplementary descriptive information, which may perform relevance determination based on more information, improve the accuracy of the relevance ranking, so that the obtained expanded pages are more relevant to the seed page and associated pages, and the obtained expanded descriptive information is more accurate. In this way, based on the expanded descriptive information, declarative descriptive information, and supplementary descriptive information, the generated reasoning chain is more matching the preset question types (multi-hop questions and/or set questions), and the generation efficiency of document question-answering data is improved.

For step 202 in FIG. 2 above, in the process of generating a reasoning chain corresponding to the seed page by using a preset question-answering data generation model, different types of question definitions and question examples may be selected to generate the reasoning chain based on the number of entities in the descriptive information. Two specific implementation manners are given below.

In some embodiments, generating a reasoning chain corresponding to the seed pages by using a preset question-answering data generation model based on the descriptive information, question definitions of preset question types, and question-answering examples of the preset question types includes: in response to determining that the descriptive information only includes one entity by using the preset question-answering data generation model; determining a jump relationship of the entity in the descriptive information by using the preset question-answering data generation model based on the question definition of the multi-hop questions and the question-answering examples of the multi-hop questions; and generating the reasoning chain corresponding to the seed pages based on the jump relationship.

In some embodiments, generating a reasoning chain corresponding to the seed pages by using a preset question-answering data generation model based on the descriptive information, question definitions of preset question types, and question-answering examples of the preset question types includes: in response to determining that the descriptive information contains multiple entities by using the preset question-answering data generation model; determining a set relationship of the entities in the descriptive information by using the preset question-answering data generation model based on the question definition of the set questions and the question-answering examples of the set questions; and generating the reasoning chain corresponding to the seed pages based on the set relationship.

Specifically, as described above, a multi-hop question is generally aimed at performing deeper logical reasoning on a given entity, while a set question is generally aimed at performing combined operations on multiple entities. Therefore, when the descriptive information only contains one entity, it is very likely that a multi-hop question may be formed based on the descriptive information. Therefore, the preset question-answering data generation model may directly perform relevant reasoning on the descriptive information based on the question definition of the multi-hop question and the question-answering example of the multi-hop question. Similarly, when the descriptive information contains multiple entities, it is very likely that a set question may be formed based on the descriptive information. Therefore, the preset question-answering data generation model may directly perform relevant reasoning on the descriptive information based on the question definition of the set question and the question-answering example of the set question. In this way, the efficiency and accuracy of generating the reasoning chain by the question-answering data generation model may be improved.

In some embodiments, the set questions include set-intersection questions, set-union questions, and set-difference questions.

Specifically, a set-intersection question needs to find elements or information that exist in common among multiple objective facts, and the answer is the intersection of these objective facts. For example, among students who are both in the basketball team and the math club, what is the highest score, it is necessary to first find students who are both in the basketball team and the math club, and then solve for their highest score.

A set-union question needs to find a logical OR relationship between multiple objective facts, and the answer is the union of these objective facts. For example, among employees working in the finance department or the human resources department, what is the highest salary, it is necessary to first find employees in the finance department or the human resources department, and then solve for the maximum value of their salaries.

A set-difference question needs to find a relationship between multiple objective facts that is A or non-B, that is, the two conditions cannot be satisfied at the same time, and the answer is the difference set of these objective facts. For example, among employees working in the sales department but not in the marketing department, what is the highest salary, it is necessary to first find employees in the sales department, see if they work in the marketing department, find employees who do not work in the marketing department, and solve for their highest salary.

For different set types in set questions, different question definitions and question examples are adopted, so that reasoning chains for different types of set question types may be generated for descriptive information, and the richness and diversity of the finally generated document question-answering data are improved.

The seed page in the present disclosure may be a page image randomly selected from all page images in the document, or selected based on specific requirements. A specific implementation manner is given below.

In some embodiments, the method not only includes the above steps 201˜203, but also includes: selecting one page image from the document as the seed page based on a service field and a service objective corresponding to the document.

Specifically, the seed page usually selects the page in the document that best represents the service core, starts the project, or provides an overview. It may be a cover page, table of contents, executive summary, key content page, etc., used as a reference, starting point, or promotional material. For different service fields and service objectives, the position of the service core in the document may be different.

For example, if the document is a business plan, its corresponding business field is entrepreneurship/technology, and the business objective is to attract investors or partners. For a business plan, the executive summary generally provides a condensed version of the entire business plan, including business concepts, market opportunities, financial forecasts, and investment needs. Therefore, using the summary as the seed page makes the generated question-answering data more targeted and of higher quality.

For another example, the document is a product brochure, the service field is consumer goods, and the service objective is to attract potential customers and stimulate purchase desire. For a product brochure, the introduction of the flagship product is generally the core of the product brochure. Therefore, the page image corresponding to the introduction of the flagship product may be used as the seed page. Therefore, using the page image corresponding to the introduction of the flagship product as the seed page makes the generated question-answering data more able to reflect the characteristics of the flagship product, thereby more able to attract users' attention, achieve the purpose of product promotion, and improve the generation quality of question-answering data.

By selecting the seed page based on the business field and service objective corresponding to the document, the embodiment of the present disclosure generates question-answering data starting from the seed page, making the generated question-answering data more targeted and improving the quality of the question-answering data.

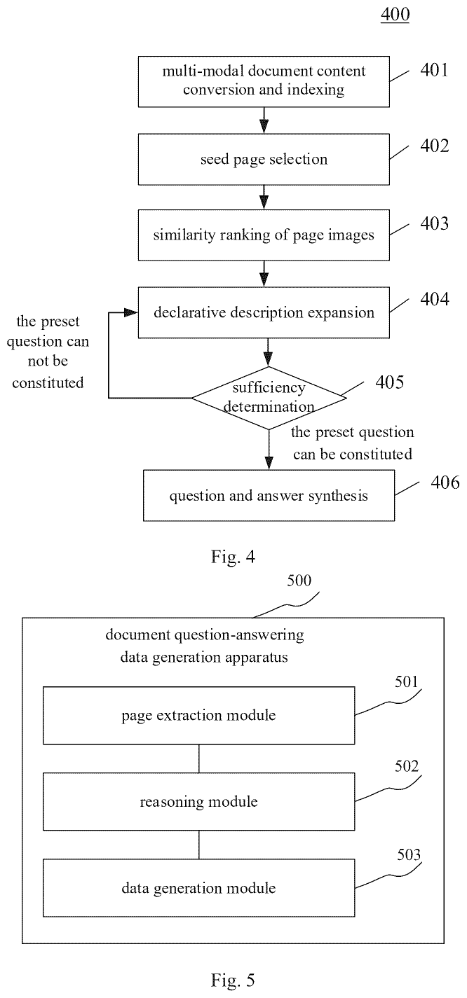

To deepen understanding, the present disclosure also provides a specific implementation scheme combined with a specific application scenario, please refer to the process 400 shown in FIG. 4. The method specifically includes the following steps.

Step 401 includes: multi-modal document content conversion and indexing.

Specifically, a multi-modal document

$$𝒟 = {\{ {p}_{i} \}}_{i = 1}^{N}$$

is regarded as a set composed of a series of page images pᵢ. First, a multi-modal large language model (MLLM, Multi-modal Large Language Model) is used to comprehensively parse the page content of each page image. MLLM takes images and text as inputs and outputs text. Specifically, for each page image, MLLM is used to perform joint understanding of vision and text, extract structured content such as text blocks, tables, and image descriptions in the page, and output in the form of text. The formula is expressed as:

tᵢ=MLLM(pᵢ), where tᵢ represents the result of text content conversion of the page pᵢ. After that, a pre-trained vision-language model, denoted as VLM, is used to convert each page image into a vector form for subsequent retrieval. VLM may encode both text and images, and may map both to a fixed-length vector. This process may be expressed as:

E=e₁, e₂, . . . , eₙ=VLM (p₁, p₂, . . . , pₙ), where E is a matrix composed of vectors of length d, corresponding to the vector representation of each page in the document.

Step 402 includes: seed page selection.

Specifically, after obtaining the above document content, a question for the document D is constructed starting from the seed page. First, randomly select one page pᵢ from all pages as the seed page. According to the text content tᵢ of this page, a multi-modal large language model is used to obtain a declarative description sᵢ. The process is as follows:

$${p}_{i} = random ( D ) ,$$

$${s}_{i} = M L L M ( {t}_{i} , {p}_{i} ) ,$$

each sᵢ may be regarded as a statement of an objective fact, such as “The result of indicator B of model X on data set A is C”. It should be noted that the declarative description may come from any content of the page, such as pictures, text, tables, etc.

Step 403 includes: similarity ranking of page images.

Specifically, after obtaining a declarative description sᵢ, the pre-trained vision-language model VLM is used to encode the declarative description sᵢ, retrieve candidate pages most similar to the declarative description sᵢ, and obtain a ranking of a page list by calculating similarity. The pages in the page list contain information related to the declarative description sᵢ. In addition, it should be noted that after obtaining the ranking of pages, the seed page needs to be excluded. The overall process is:

$$v = V L M ( {s}_{i} ) ,$$

$$S = sim ( v , E ) ,$$

where v represents the vector encoding of the declarative description sᵢ, sim is a cosine similarity calculation function, S is the similarity score of v for each page in the document, and a ranking r=argsort(S) for each page may be obtained according to this score.

Then, the multi-modal large language model MLLM is used, based on the above page ranking argsort(S), to select pages with the highest similarity in sequence, for executing the following steps 404˜406 in sequence.

Step 404 includes: declarative description expansion.

For the declarative description, a current page is searched for supplementary descriptions related to the declarative description. Relevant may be defined as overlapping with the declarative description, which may be related a given entity (for example, both describing model X) and related to a given characteristic (both being conclusive descriptions). The page content is extracted through the multi-modal large language model:

$${s}_{j}^{*} = M L L M ( {r}_{j} , {p}_{j} ) ,$$

where s*ᵢ represents other supplementary descriptions in the page.

Step 405 includes: sufficiency determination.

Combined with the existing supplementary descriptions and the original declarative descriptions, and the definitions of preset questions (multi-hop questions or set questions), whether the preset questions may be formed is determined. Optionally, a large language model LLM may be used as a reasoner to output a binary value yes or no, indicating whether the current supplementary descriptions and declarative descriptions are sufficient:

$${R}_{j} , {o}_{j} = L L M ( {s}_{j}^{*} , {s}_{i} , {d}_{1} , {ctx}_{1} ) ,$$

where oⱼ is a binary value indicating whether a preset question may be formed, Rⱼ is the reasoning chain reasoning process indicating the reason for making the determination, d1 represents the specific definition of the preset question, and ctx₁ represents the context example of the preset question. If it is determined by the above LLM that the preset question may be constituted, step 406 is proceeded; if it is determined by the above LLM that the preset question cannot be constituted, step 404 is proceeded, to continue selecting a next page based on the similarity ranking, and expanding the content of the supplementary description until it is determined by the above LLM that the preset question may be constituted, then step 406 is proceeded.

Step 406 includes: question and answer synthesis.

Specifically, if the current declarative description and supplementary description may meet the definition of a random question, that is, a preset question may be constituted, then the large language model LLM is used to synthesize the question. According to the sufficiency determination reason obtained in step 405, combined with the declarative description and supplementary description, the question and answer is synthesized:

$${a}_{j} , {q}_{j} = L L M ( {s}_{j}^{*} , {s}_{i} , {d}_{1} , {R}_{j} ) ,$$

where d₁ represents the definition of the preset question, Rⱼ represents the reason for the sufficiency determination, and qⱼ and aⱼ respectively represent the synthesized question and answer.

The preset questions may be multi-hop questions, intersection questions, union questions, and difference questions. For different types of question types, the main difference lies in the definition of different types of questions in step 405 and the corresponding context examples of the questions. Other processes are consistent with the synthesis process of multi-hop questions.

The method for generating document question-answering data provided by the present disclosure first obtains descriptive information of seed pages by extracting page content from page images in a document, then performs reasoning by using a preset question-answering data generation model based on the descriptive information, question definitions of preset questions, and examples of preset questions, determines whether question-answering data corresponding to the preset questions may be generated based on the descriptive information, and generates corresponding question-answering data when the question-answering data corresponding to the preset questions may be generated based on the descriptive information. The preset question types include multi-hop questions and/or set questions. Thus, the present disclosure may generate complex question-answering data including multi-hop questions and/or set questions based on the descriptive information, improving the quality, diversity, and difficulty of the question-answering data.

Further, document question-answering data may be applied in the field of document processing and retrieval-augmented generation. In the field of document processing and retrieval enhancement, a multi-modal question-answering model is usually used to deeply understand document content and accurately answer user questions.

The present disclosure also provides a training method for a question-answering model. The method specifically includes: obtaining document question-answering data samples; and inputting the document question-answering data samples into the question-answering model to train the question-answering model.

The document question-answering data samples are constructed by using the method described in any one of the above embodiments of the document question-answering data generation method, which will not be repeated here.

The embodiment of the present disclosure constructs training data of the question-answering model based on the document question-answering data obtained in any of the above document data generation embodiments. Since the document question-answering data obtained according to any of the above embodiments covers complex question types such as multi-step reasoning and set questions. The embodiments of the above document data generation method automatically construct complex, multi-hop multi-modal document questions and their corresponding answers through operations such as multi-hop questions, set-intersection, union, and difference, effectively improving the scale and quality of training data, providing a solid data foundation for model training, and meeting the actual training data needs of products such as intelligent document processing and intelligent retrieval. Therefore, the question-answering model trained based on the document question-answering data has stronger generalization ability and better performance in practical applications.

Further referring to FIG. 5, as an implementation of the methods shown in the above figures, the present disclosure provides an embodiment of a document question-answering data generation apparatus. The apparatus embodiment corresponds to the method embodiment shown in FIG. 2. The apparatus may be specifically applied to various electronic devices.

As shown in FIG. 5, the document question-answering data generation apparatus 500 of this embodiment may include: a page extraction module 501, a reasoning module 502, and a data generation module. The page extraction module 501 is configured to extract page content from page images in a document to obtain descriptive information corresponding to seed pages in the document; the reasoning module 502 is configured to generate a reasoning chain corresponding to the seed pages by using a preset question-answering data generation model based on the descriptive information, question definitions of preset question types, and question-answering examples of the preset question types; where the preset question types include multi-hop questions and/or set questions; the data generation module 503 is configured to generate question-answering data corresponding to the preset question types by using the question-answering data generation model based on the question-type reasoning chain in response to the reasoning chain constituting the question-type reasoning chain corresponding to the preset question types.

In this embodiment, in the document question-answering data generation apparatus 500: the specific processing of the page extraction module 501, the reasoning module 502, and the data generation module and the technical effects brought thereby may refer to the relevant descriptions of steps 201-203 in the embodiment corresponding to FIG. 2, which will not be repeated here.

In some embodiments, the preset question types include multi-hop questions and set questions; correspondingly, the question-type reasoning chain is a chained reasoning chain corresponding to the multi-hop questions and/or a set-operation reasoning chain corresponding to the set questions. The data generation module 503 is specifically configured to generate multi-hop question-answering data corresponding to the chained reasoning chain and/or set question-answering data corresponding to the set-operation reasoning chain by using the question-answering data generation model based on the reasoning chain in response to the reasoning chain including the chained reasoning chain corresponding to the multi-hop questions and/or the set-operation reasoning chain corresponding to the set questions. In some embodiments, the page extraction module 501 is specifically configured to extract page content from page images in the document to obtain text information of the page images; and process the page images and the corresponding text information by using a preset multi-modal model to obtain descriptive information corresponding to the seed pages in the document.

In some embodiments, the descriptive information includes declarative descriptive information and supplementary descriptive information; the page extraction module 501 is specifically configured to extract page content from page images of the seed pages by using a preset multi-modal model to generate text information corresponding to the seed pages, and generate declarative descriptive information of the seed pages based on the page images of the seed pages and the corresponding text information; perform relevance ranking on the page images in the document based on the declarative descriptive information of the seed pages to obtain associated pages of the seed pages; extract page content from page images of the associated pages by using the multi-modal model to generate text information corresponding to the associated pages, and process the page images of the associated pages and the corresponding text information to generate supplementary descriptive information of the seed pages; and obtain the descriptive information of the seed pages based on the declarative descriptive information and the supplementary descriptive information.

In some embodiments, the page extraction module 501 is specifically configured to determine entities and/or relationships contained in the seed pages based on the declarative descriptive information of the seed pages; retrieve page images containing the entities and/or relationships from the page images in the document to obtain candidate pages; and perform relevance ranking on the candidate pages to obtain associated pages of the seed pages.

In some embodiments, the page extraction module 501 is specifically configured to perform vector encoding on each page image in the document to obtain an encoded vector corresponding to each page image; perform vector encoding on the declarative descriptive information of the seed pages to obtain an encoded description corresponding to the declarative descriptive information; calculate a similarity score between each encoded vector and the encoded description to obtain a similarity ranking; and determine associated pages of the seed pages based on the similarity ranking.

In some embodiments, the document question-answering data generation apparatus 500 not only includes: a page extraction module 501, a reasoning module 502, and a data generation module, but also includes an expansion module configured to expand the associated pages based on the similarity ranking to obtain expanded pages in response to the reasoning chain not including a reasoning chain corresponding to the preset question types; process the page images of the expanded pages and the corresponding text information by using the multi-modal model to generate expanded descriptive information of the seed page; and regenerate the reasoning chain corresponding to the seed page based on the expanded descriptive information.

In some embodiments, the reasoning module 502 is specifically configured to: in response to determining that the descriptive information only includes one entity by using the preset question-answering data generation model; determine a jump relationship of the entity in the descriptive information by using the preset question-answering data generation model based on the question definition of the multi-hop questions and the question-answering examples of the multi-hop questions; generate the reasoning chain corresponding to the seed pages based on the jump relationship.

In some embodiments, the reasoning module 502 is specifically configured to: in response to determining that the descriptive information contains multiple entities by using the preset question-answering data generation model; determine a set relationship of the entities in the descriptive information by using the preset question-answering data generation model based on the question definition of the set questions and the question-answering examples of the set questions; and generate the reasoning chain corresponding to the seed pages based on the set relationship.

In some embodiments, the set questions include set-intersection questions, set-union questions, and set-difference questions.

In some embodiments, the apparatus not only includes: a page extraction module 501, a reasoning module 502, and a data generation module, but also includes a selection module specifically configured to: select one page image from the document as the seed page based on a service field and a service objective corresponding to the document.

This embodiment exists as an apparatus embodiment corresponding to the above method embodiment. The document question-answering data generation apparatus provided by this embodiment first obtains descriptive information of seed pages by extracting page content from page images in a document, then performs reasoning by using a preset question-answering data generation model based on the descriptive information, question definitions of preset questions, and examples of preset questions, determines whether question-answering data corresponding to the preset questions can be generated based on the descriptive information, and generates corresponding question-answering data when the question-answering data corresponding to the preset questions may be generated based on the descriptive information. The preset question types include multi-hop questions and/or set questions. Thus, the present disclosure may generate complex question-answering data including multi-hop questions and/or set questions based on the descriptive information, improving the quality, diversity, and difficulty of the question-answering data.

According to an embodiment of the present disclosure, the present disclosure also provides an electronic device, the electronic device including: at least one processor; and a memory communicatively connected to the at least one processor; where the memory stores instructions executable by the at least one processor, and the instructions are executed by the at least one processor to enable the at least one processor to implement the document question-answering data generation method described in any one of the above embodiments when executed.

According to an embodiment of the present disclosure, the present disclosure also provides a readable storage medium storing computer instructions, the computer instructions being used to enable a computer to implement the document question-answering data generation method described in any one of the above embodiments when executed.

According to an embodiment of the present disclosure, the present disclosure also provides a computer program product including a computer program, the computer program being capable of implementing the document question-answering data generation method described in any one of the above embodiments when executed by a processor.

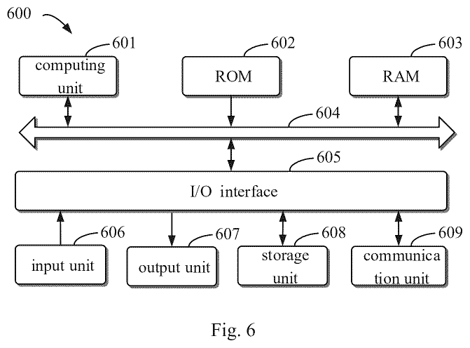

FIG. 6 shows a schematic block diagram of an exemplary electronic device 600 that may be used to implement embodiments of the present disclosure. Electronic device is intended to represent various forms of digital computers, such as laptop computers, desktop computers, workstations, personal digital assistants, servers, blade servers, mainframe computers, and other suitable computers. Electronic device may also represent various forms of mobile devices, such as personal digital processing, cellular telephones, smart phones, wearable devices, and other similar computing devices. The components shown herein, their connections and relationships, and their functions are merely examples, and are not intended to limit the implementations of the present disclosure described and/or required herein.

As shown in FIG. 6, electronic device 600 includes a computing unit 601, which may execute various appropriate actions and processes according to a computer program stored in a read-only memory (ROM) 602 or a computer program loaded from a storage unit 608 into a random access memory (RAM) 603. In RAM 603, various programs and data required for the operation of electronic device 600 may also be stored. Computing unit 601, ROM 602, and RAM 603 are connected to each other through a bus 604. An input/output (I/O) interface 605 is also connected to bus 604.

A plurality of components in electronic device 600 are connected to I/O interface 605, including: an input unit 606, such as a keyboard, a mouse, etc.; an output unit 607, such as various types of displays, speakers, etc.; a storage unit 608, such as a magnetic disk, an optical disk, etc.; and a communication unit 609, such as a network card, a modem, a wireless communication transceiver, etc. Communication unit 609 allows electronic device 600 to exchange information/data with other devices through a computer network such as the Internet and/or various telecommunication networks.

The computing unit 601 may be various general-purpose and/or special-purpose processing components with processing and computing capabilities. Examples of the computing unit 601 include, but are not limited to, a Central Processing Unit (CPU), a Graphics Processing Unit (GPU), various dedicated Artificial Intelligence (AI) computing chips, various computing units running machine learning model algorithms, a Digital Signal Processor (DSP), and any suitable processor, controller, microcontroller, etc. The computing unit 601 executes each of the methods and processes described above, such as the document question-answering data generation method. For example, in some embodiments, the document question-answering data generation method may be implemented as a computer software program tangibly embodied in a machine-readable medium, such as the storage unit 608. In some embodiments, part or all of the computer program may be loaded into and/or installed on the electronic device 600 via the ROM 602 and/or the communication unit 609. When the computer program is loaded into the RAM 603 and executed by the computing unit 601, one or more steps of the document question-answering data generation method described above may be executed. Alternatively, in other embodiments, the computing unit 601 may be configured to execute the document question-answering data generation method in any other suitable manner (e.g., by means of firmware).

The various embodiments of the systems and techniques described above herein may be implemented in a digital electronic circuit system, an integrated circuit system, a field programmable gate array (FPGA), an application specific integrated circuit (ASIC), a special purpose standard product (ASSP), a system on a system on a chip (SOC), a load programmable logic device (CPLD), computer hardware, firmware, software, and/or combinations thereof. These various embodiments may include being implemented in one or more computer programs that may execute and/or interpret on a programmable system including at least one programmable processor, which may be a dedicated or general purpose programmable processor that may receive data and instructions from a memory system, at least one input device, and at least one output device, and transmit the data and instructions to the memory system, the at least one input device, and the at least one output device.

The program code for carrying out the methods of the present disclosure may be written in any combination of one or more programming languages. These program codes may be provided to a processor or controller of a general purpose computer, special purpose computer, or other programmable data processing apparatus such that the program code, when executed by the processor or controller, causes the functions/operations specified in the flowchart and/or block diagram to be implemented. The program code may be executed entirely on the machine, partly on the machine, partly on the machine as a stand-alone software package and partly on the remote machine or entirely on the remote machine or server.

In the context of the present disclosure, a machine-readable medium may be a tangible medium that may contain or store a program for use by or in connection with an instruction execution system, apparatus, or device. The machine-readable medium may be a machine-readable signal medium or a machine-readable storage medium. The machine-readable medium may include, but is not limited to, electronic, magnetic, optical, electromagnetic, infrared, or semiconductor systems, devices, or devices, or any suitable combination of the foregoing. More specific examples of machine-readable storage media may include one or more wire-based electrical connections, portable computer disks, hard disks, random access memory (RAM), read-only memory (ROM), erasable programmable read-only memory (EPROM or flash memory), optical fibers, portable compact disk read-only memory (CD-ROM), optical storage devices, magnetic storage devices, or any suitable combination of the foregoing.

To provide interaction with a user, the systems and techniques described herein may be implemented on a computer having a display device (e.g., a CRT (cathode ray tube) or LCD (liquid crystal display) monitor) for displaying information to the user; and a keyboard and a pointing device (e.g., a mouse or a trackball) through which a user may provide input to a computer. Other types of devices may also be used to provide interaction with a user; for example, the feedback provided to the user may be any form of sensory feedback (e.g., visual feedback, auditory feedback, or tactile feedback); and input from the user may be received in any form, including acoustic input, speech input, or tactile input.

The systems and techniques described herein may be implemented in a computing system including a background component (e.g., as a data server), or a computing system including a middleware component (e.g., an application server), or a computing system including a front-end component (e.g., a user computer having a graphical user interface or a web browser through which a user may interact with embodiments of the systems and techniques described herein), or a computing system including any combination of such background component, middleware component, or front-end component. The components of the system may be interconnected by any form or medium of digital data communication (e.g., a communication network). Examples of communication networks include a local area network (LAN), a wide area network (WAN), and the Internet.

A computer system may include a client and a server. The client and the server are generally remote from each other and typically interact via a communication network. The client-server relationship is generated by computer programs running on respective computers and having a client-server relationship with each other. The server may be a cloud server, also known as a cloud computing server or cloud host, which is a host product in the cloud computing service system. It addresses the drawbacks of high management difficulty and weak business scalability existing in traditional physical hosts and Virtual Private Server (VPS) services.

According to the technical solution of the embodiments of the present disclosure, descriptive information of seed pages is first obtained by extracting page content from page images in a document. Then, based on the descriptive information, question definitions of preset questions, and examples of preset questions, a preset question-answering data generation model is used to perform reasoning to determine whether question-answering data corresponding to the preset questions may be generated based on the descriptive information. When the question-answering data corresponding to the preset questions may be generated based on the descriptive information, the corresponding question-answering data is generated. Among them, the preset question types include multi-hop questions and/or set questions. Thus, the present disclosure can generate complex question-answering data including multi-hop questions and/or set questions based on the descriptive information, improving the quality, diversity, and difficulty of the question-answering data.

It should be understood that the steps of reordering, adding or deleting may be performed using the various forms shown above. For example, the steps described in the present disclosure may be performed in parallel or sequentially or in a different order, so long as the desired results of the technical solution disclosed in the present disclosure can be realized, and no limitation is imposed herein.

The foregoing detailed description is not intended to limit the scope of the present disclosure. It will be appreciated by those skilled in the art that various modifications, combinations, sub-combinations, and substitutions may be made depending on design requirements and other factors. Any modifications, equivalents, and modifications that fall within the spirit and principles of the disclosure are intended to be included within the scope of protection of the disclosure.

What is claimed is:

1. A method for generating document question-answering data, comprising:
extracting page content from page images in a document to obtain descriptive information corresponding to seed pages in the document;
generating a reasoning chain corresponding to the seed pages by using a preset question-answering data generation model based on the descriptive information, question definitions of preset question types, and question-answering examples of the preset question types, wherein the preset question types include multi-hop questions and/or set questions; and
in response to the reasoning chain constituting a question-type reasoning chain corresponding to the preset question types, generating question-answering data corresponding to the preset question types by using the question-answering data generation model based on the question-type reasoning chain.

2. The method according to claim 1, wherein the preset question types include multi-hop questions and set questions; correspondingly, the question-type reasoning chain is a chained reasoning chain corresponding to the multi-hop questions and/or a set-operation reasoning chain corresponding to the set questions;
the generating question-answering data corresponding to the preset question types by using the question-answering data generation model based on the question-type reasoning chain in response to the reasoning chain constituting the question-type reasoning chain corresponding to the preset question types comprises:
in response to the reasoning chain constituting the question-type reasoning chain corresponding to the preset question types, generating multi-hop question-answering data corresponding to the chained reasoning chain and/or set question-answering data corresponding to the set-operation reasoning chain by using the question-answering data generation model based on the question-type reasoning chain.

3. The method according to claim 1, wherein the extracting the page content from page images in the document to obtain descriptive information corresponding to seed pages in the document comprises:
extracting page content from page images in the document to obtain text information of the page images; and
processing the page images and the corresponding text information by using a preset multi-modal model to obtain descriptive information corresponding to the seed pages in the document.

4. The method according to claim 3, wherein the descriptive information includes declarative descriptive information and supplementary descriptive information;
the extracting page content from page images in the document to obtain descriptive information corresponding to seed pages in the document comprises:
extracting page content from page images of the seed pages by using the preset multi-modal model to generate text information corresponding to the seed pages, and generating declarative descriptive information of the seed pages based on the page images of the seed pages and the corresponding text information;
performing relevance ranking on the page images in the document based on the declarative descriptive information of the seed pages to obtain associated pages of the seed pages;
extracting page content from page images of the associated pages by using the multi-modal model to generate text information corresponding to the associated pages, and processing the page images of the associated pages and the corresponding text information to generate supplementary descriptive information of the seed pages; and
obtaining the descriptive information of the seed pages based on the declarative descriptive information and the supplementary descriptive information.

5. The method according to claim 4, wherein the performing the relevance ranking on the page images in the document based on the declarative descriptive information of the seed pages to obtain associated pages of the seed pages comprises:
determining entities and/or relationships contained in the seed pages based on the declarative descriptive information of the seed pages;
retrieving page images containing the entities and/or relationships from the page images in the document to obtain candidate pages; and
performing relevance ranking on the candidate pages to obtain associated pages of the seed pages.

6. The method according to claim 4, wherein the performing the relevance ranking on the page images in the document based on the declarative descriptive information of the seed pages to obtain associated pages of the seed pages comprises:
performing vector encoding on each page image in the document to obtain an encoded vector corresponding to each page image;
performing vector encoding on the declarative descriptive information of the seed pages to obtain an encoded description corresponding to the declarative descriptive information;
calculating a similarity score between each encoded vector and the encoded description to obtain a similarity ranking; and
determining associated pages of the seed pages based on the similarity ranking.

7. The method according to claim 4, further comprising:
in response to the reasoning chain not constituting the question-type reasoning chain corresponding to the preset question types, expanding the associated pages based on the similarity ranking to obtain expanded pages;
processing the page images of the expanded pages and the corresponding text information by using the multi-modal model to generate expanded descriptive information of the seed pages; and
regenerating the reasoning chain corresponding to the seed pages based on the expanded descriptive information.

8. The method according to claim 1, wherein the generating the reasoning chain corresponding to the seed pages by using the preset question-answering data generation model based on the descriptive information, the question definitions of preset question types, and the question-answering examples of the preset question types comprises:
in response to determining that the descriptive information only includes one entity by using the preset question-answering data generation model;
determining a jump relationship of the entity in the descriptive information by using the preset question-answering data generation model based on the question definition of the multi-hop questions and the question-answering examples of the multi-hop questions; and
generating the reasoning chain corresponding to the seed pages based on the jump relationship.

9. The method according to claim 1, wherein the generating the reasoning chain corresponding to the seed pages by using the preset question-answering data generation model based on the descriptive information, question definitions of preset question types, and question-answering examples of the preset question types comprises:
in response to determining that the descriptive information includes a plurality of entities by using the preset question-answering data generation model;
determining a set relationship of the plurality of entities in the descriptive information by using the preset question-answering data generation model based on the question definition of the set questions and the question-answering examples of the set questions; and
generating the reasoning chain corresponding to the seed pages based on the set relationship.

10. The method according to claim 1, wherein the set questions include set-intersection questions, set-union questions, and set-difference questions.

11. The method according to claim 1, further comprising:
selecting one page image from the document as the seed page based on a service field and a service objective corresponding to the document.

12. The method according to claim 1, wherein the question-answering data corresponding to the preset question types are used as document question-answering data samples, and the method further comprises: inputting the document question-answering data samples into the question-answering model to train the question-answering model.

13. An electronic device, comprising:
at least one processor; and
a memory communicatively connected to the at least one processor; wherein,
the memory stores instructions executable by the at least one processor, and the instructions are executed by the at least one processor to enable the at least one processor to perform operations:
extracting page content from page images in a document to obtain descriptive information corresponding to seed pages in the document;
generating a reasoning chain corresponding to the seed pages by using a preset question-answering data generation model based on the descriptive information, question definitions of preset question types, and question-answering examples of the preset question types, wherein the preset question types include multi-hop questions and/or set questions; and
in response to the reasoning chain constituting a question-type reasoning chain corresponding to the preset question types, generating question-answering data corresponding to the preset question types by using the question-answering data generation model based on the question-type reasoning chain.

14. The electronic device according to claim 13, wherein the preset question types include multi-hop questions and set questions; correspondingly, the question-type reasoning chain is a chained reasoning chain corresponding to the multi-hop questions and/or a set-operation reasoning chain corresponding to the set questions;
the generating question-answering data corresponding to the preset question types by using the question-answering data generation model based on the question-type reasoning chain in response to the reasoning chain constituting the question-type reasoning chain corresponding to the preset question types comprises:
in response to the reasoning chain constituting the question-type reasoning chain corresponding to the preset question types, generating multi-hop question-answering data corresponding to the chained reasoning chain and/or set question-answering data corresponding to the set-operation reasoning chain by using the question-answering data generation model based on the question-type reasoning chain.

15. The electronic device according to claim 13, wherein the extracting the page content from page images in the document to obtain descriptive information corresponding to seed pages in the document comprises:
extracting page content from page images in the document to obtain text information of the page images; and
processing the page images and the corresponding text information by using a preset multi-modal model to obtain descriptive information corresponding to the seed pages in the document.

16. The electronic device according to claim 15, wherein the descriptive information includes declarative descriptive information and supplementary descriptive information;
the extracting page content from page images in the document to obtain descriptive information corresponding to seed pages in the document comprises:
extracting page content from page images of the seed pages by using the preset multi-modal model to generate text information corresponding to the seed pages, and generating declarative descriptive information of the seed pages based on the page images of the seed pages and the corresponding text information;
performing relevance ranking on the page images in the document based on the declarative descriptive information of the seed pages to obtain associated pages of the seed pages;
extracting page content from page images of the associated pages by using the multi-modal model to generate text information corresponding to the associated pages, and processing the page images of the associated pages and the corresponding text information to generate supplementary descriptive information of the seed pages; and
obtaining the descriptive information of the seed pages based on the declarative descriptive information and the supplementary descriptive information.

17. The electronic device according to claim 16, wherein the performing the relevance ranking on the page images in the document based on the declarative descriptive information of the seed pages to obtain associated pages of the seed pages comprises:
determining entities and/or relationships contained in the seed pages based on the declarative descriptive information of the seed pages;
retrieving page images containing the entities and/or relationships from the page images in the document to obtain candidate pages; and
performing relevance ranking on the candidate pages to obtain associated pages of the seed pages.

18. The electronic device according to claim 16, wherein the performing the relevance ranking on the page images in the document based on the declarative descriptive information of the seed pages to obtain associated pages of the seed pages comprises:
performing vector encoding on each page image in the document to obtain an encoded vector corresponding to each page image;
performing vector encoding on the declarative descriptive information of the seed pages to obtain an encoded description corresponding to the declarative descriptive information;
calculating a similarity score between each encoded vector and the encoded description to obtain a similarity ranking; and
determining associated pages of the seed pages based on the similarity ranking.

19. The electronic device according to claim 16, wherein the operations further comprises:
in response to the reasoning chain not constituting the question-type reasoning chain corresponding to the preset question types, expanding the associated pages based on the similarity ranking to obtain expanded pages;
processing the page images of the expanded pages and the corresponding text information by using the multi-modal model to generate expanded descriptive information of the seed pages; and
regenerating the reasoning chain corresponding to the seed pages based on the expanded descriptive information.

20. A non-transitory computer-readable storage medium storing computer instructions, wherein the computer instructions are used to enable a computer to perform operations comprising:
extracting page content from page images in a document to obtain descriptive information corresponding to seed pages in the document;
generating a reasoning chain corresponding to the seed pages by using a preset question-answering data generation model based on the descriptive information, question definitions of preset question types, and question-answering examples of the preset question types, wherein the preset question types include multi-hop questions and/or set questions; and
in response to the reasoning chain constituting a question-type reasoning chain corresponding to the preset question types, generating question-answering data corresponding to the preset question types by using the question-answering data generation model based on the question-type reasoning chain.
